(19) United States
(12) Patent Application Publication
(10) Pub. No.: US 2014/0006010 A1
(43) Pub. Date: Jan. 2, 2014

(54) PARSING RULES FOR DATA

(71) Applicants: Igor Nor, Haifa (IL); Ron Maurer, Haifa (IL)

(72) Inventors: Igor Nor, Haifa (IL); Ron Maurer, Haifa (IL)

(21) Appl. No.: 13/534,342

(22) Filed: Jun. 27, 2012

(51) Int. Cl. G06F 17/27

(52) U.S. Cl. 704/9

(57) ABSTRACT

Disclosed herein are techniques for formulating parsing rules. Substrings are detected in an input data. Each substring is associated with a semantic token that categorizes each substring. Patterns of semantic tokens are identified. Rules for parsing the input data are formulated based at least partially on the patterns of semantic tokens.

### BACKGROUND

System log files may be used to diagnose and resolve system failures and performance bottlenecks in computer systems. Such log files may be generated by the software modules included in the system. Software developers may insert source code in these modules to create log messages at different points of the program. These messages may allow support engineers to determine the status of a system's components when a failure or bottleneck occurred.

### BRIEF DESCRIPTION OF THE DRAWINGS

FIG. 1 is a block diagram of an example computer apparatus for enabling the parsing techniques disclosed herein.

FIG. 2 is an example method in accordance with aspects of the present disclosure.

FIG. 3 is an example log file and an associated semantic string in accordance with aspects of the present disclosure.

FIG. 4 is a working example of a suffix tree data structure in accordance with aspects of the present disclosure.

### DETAILED DESCRIPTION

As noted above, software modules of a system may be encoded with instructions to produce log messages at different points in the program. These log messages may assist a system engineer in diagnosing system failures or performance bottlenecks. Unfortunately, textual log formats are not sufficiently standardized. There are thousands of log formats in use today, some of which are unique to a certain system. Without knowing the log-format in advance, it is difficult to parse the log into separate records (e.g., log-messages). Log-analysis software may not operate correctly, unless the rules for parsing the records are re-programmed for each format.

In view of the increasing volumes and variability of log files handled by massive log-analysis systems, various examples disclosed herein provide a system, non-transitory computer readable medium, and method for automatic discovery of records in data and the rules to partition them. In one example, substrings may be detected in the input data. Each substring may comprise at least one character. In one example, rules for parsing records in the input data may be formulated based at least partially on the patterns of semantic tokens. The aspects, features and advantages of the present disclosure will be appreciated when considered with reference to the following description of examples and accompanying figures. The following description does not limit the application; rather, the scope of the disclosure is defined by the appended claims and equivalents.

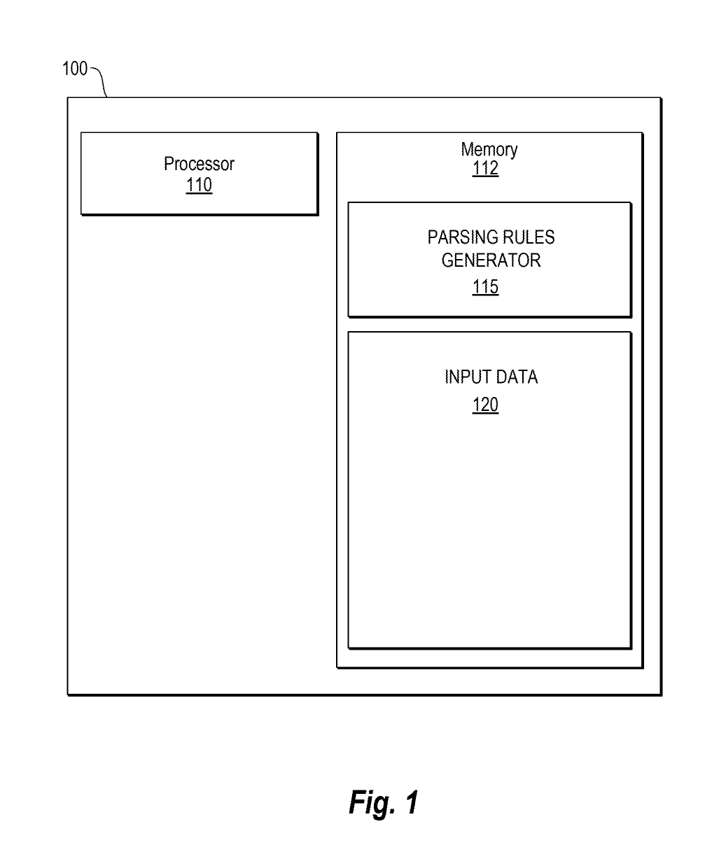

FIG. 1 presents a schematic diagram of an illustrative computer apparatus 100 depicting various components in accordance with aspects of the present disclosure. The computer apparatus 100 may include all the components normally used in connection with a computer. For example, it may have a keyboard and mouse and/or various other types of input devices such as pen-inputs, joysticks, buttons, touch screens, etc., as well as a display, which could include, for instance, a CRT, LCD, plasma screen monitor, TV, projector, etc. Computer apparatus 100 may also comprise a network interface (not shown) to communicate with other devices over a network using conventional protocols (e.g., Ethernet, Wi-Fi, Bluetooth, etc.).

The computer apparatus 100 may also contain a processor 110 and memory 112. Memory 112 may store instructions that are retrievable and executable by processor 110. In one example, memory 112 may be a random access memory (“RAM”) device. In a further example, memory 112 may be divided into multiple memory segments organized as dual in-line memory modules (DIMMs). Alternatively, memory 112 may comprise other types of devices, such as memory provided on floppy disk drives, tapes, and hard disk drives, or other storage devices that may be coupled to computer apparatus 100 directly or indirectly. The memory may also include any combination of one or more of the foregoing and/or other devices as well. The processor 110 may be any number of well known processors, such as processors from Intel® Corporation. In another example, the processor may be a dedicated controller for executing operations, such as an application specific integrated circuit (“ASIC”). Although all the components of computer apparatus 100 are functionally illustrated in FIG. 1 as being within the same block, it will be understood that the components may or may not be stored within the same physical housing. Furthermore, computer apparatus 100 may actually comprise multiple processors and memories working in tandem.

The instructions residing in memory 112 may comprise any set of instructions to be executed directly (such as machine code) or indirectly (such as scripts) by processor 110. In that regard, the terms “instructions,” “scripts,” “applications,” and “programs” may be used interchangeably herein. The computer executable instructions may be stored in any computer language or format, such as in object code or modules of source code. Furthermore, it is understood that the instructions may be implemented in the form of hardware, software, or a combination of hardware and software and that the examples herein are merely illustrative.

Parsing rules generator module 115 may implement the techniques described in the present disclosure. In that regard, parsing rules generator module 115 may be realized in any non-transitory computer-readable media for use by or in connection with an instruction execution system such as computer apparatus 100, an ASIC or other system that can fetch or obtain the logic from non-transitory computer-readable media and execute the instructions contained therein. “Non-transitory computer-readable media” may be any media that can contain, store, or maintain programs and data for use by or in connection with the instruction execution system. Non-transitory computer readable media may comprise any one of many physical media such as, for example, electronic, magnetic, optical, electromagnetic, or semiconductor media. More specific examples of suitable non-transitory computer-readable media include, but are not limited to, a portable magnetic computer diskette such as floppy diskettes or hard drives, a read-only memory (“ROM”), an erasable programmable read-only memory, or a portable compact disc.

As will be explained below, parsing rules generator module 115 may configure processor 110 to read input data, such as input data 120, and formulate parsing rules even when the format of the data is unknown. While the examples herein make reference to log files, it is understood that the techniques herein may be used to parse any type of data whose format does not adhere to any standard or format.

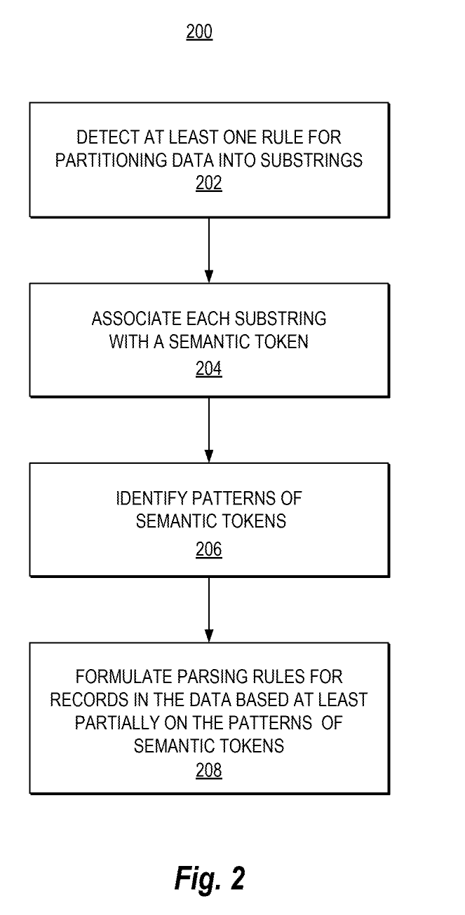

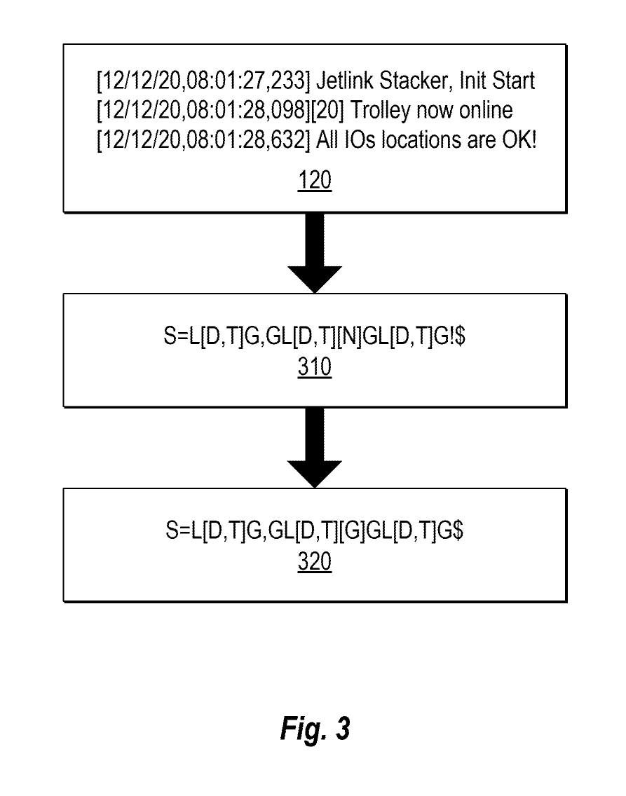

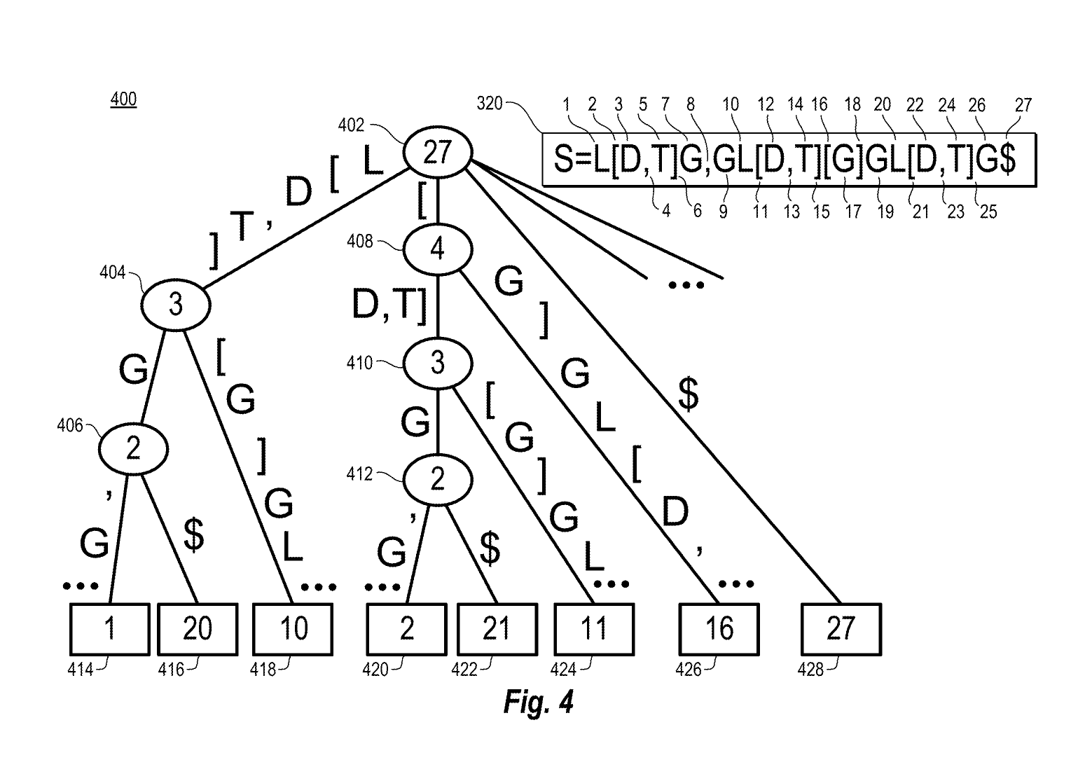

One working example of the system, method, and non-transitory computer-readable medium is shown in FIGS. 2-4. In particular, FIG. 2 illustrates a flow diagram of an example method for deriving parsing rules in accordance with the present disclosure. FIGS. 3-4 show a working example of parsing rule derivation in accordance with the techniques disclosed herein. The actions shown in FIGS. 3-4 will be discussed below with regard to the flow diagram of FIG. 2.

As shown in FIG. 2, at least one rule for partitioning data into substrings may be detected, as shown in block 202. Each substring may comprise at least one character. To detect substrings a delimiter may be detected. In one example, a delimiter may be a substring that separates other substrings in the input data. Since the parsing rules are not known in advanced, detecting the delimiter may facilitate in detecting the substrings in the input data. The following is a non-exhaustive list of candidate delimiters that may be searched in the input data:

SPACE TAB \/|!@$%̂,.:;&=˜_-.

Some substrings in the input data may be predetermined substrings associated with a predetermined type. In one example, a predetermined substring may be a substring that is presumed to appear in the input data. Such presumption may be based on advanced knowledge of the input data. For example, in the context of log files, “new line” characters, also termed line-feed (LF) characters in the ASCII standard, may be presumed, since they improve visibility and readability. It may also be presumed that the majority of lines contain at least one delimiter. Based on these assumptions, the plausibility that each candidate is the delimiter increases as the percentage of lines in which each candidate appears approaches 100%. However, this criterion may not be sufficient, since there may be other candidates that appear in the majority of lines at least once. Thus, in one example, the frequency of appearances of each candidate in the entire input data may also be considered. Each of the candidates listed above may have a plausibility score associated therewith that measures the plausibility that each candidate is a delimiter. In one example, the delimiter plausibility score may account for both considerations noted above and may be defined as the following: N×−log(P+R×(1−P)), where N is the frequency of a candidate's appearances in the input data, P is the percentage of lines in the input data that did not contain the candidate delimiter, and R is a regularization constant to avoid divergence of the logarithm. In one example, R is approximately 0.01. The chosen delimiter may be the delimiter with the highest plausibility score. During this first pass, it may be assumed that each line is delimited by the new line character.

FIG. 3 shows a close up illustration of input data 120. In the example of FIG. 3, input data 120 is a log file generated by a software module of a computer system. The possible delimiters in the input data 120 are:

SPACE “,” “/” “]” “[” “:”

The SPACE occurs 12 times in the input data. The “,” “!” and “:” occur 6 times; and, the “[” and “]” both occur 4 times. Each candidate appears in all three lines. Thus, the percentage of lines in which each candidate does not appear is 0. Inserting these numbers into the example plausibility score formula above results in the following:

SPACE=12×−log(0+0.01(1−0)=12×log(0.01)=24

“,”=6×−log(0+0.01×(1−0)=6×log(0.01)=12

“/”=6×−log(0+0.01×(1−0)=6×log(0.01)=12

“:”=6×−log(0+0.01×(1−0)=6×log(0.01)=12

“[”=4×−log(0+0.01×(1−0)=6×log(0.01)=8

“]”=4×−log(0+0.01×(1−0)=6×log(0.01)=8

Thus, in this example, the SPACE has the highest plausibility score and may be deemed the delimiter that separates the substrings in input data 120.

As noted above, appearances of some substrings may be presumed in the input data. In addition to new line characters, timestamps and dates may be presumed to appear in the context of log files, since this information may assist in diagnosing problems arising in a computer system. In the example input data 120, the substring “12/12/20” may be a predetermined substring categorized as a date substring. The substrings “08:01:27,233,” “08:01:28,098,” and “08:01:28,632” may be predetermined substrings categorized as timestamp substrings. An end of data character (not shown) that indicates the end of the input data may also be a predetermined substring presumed to be in the input data.

Referring back to FIG. 2, each substring may be associated with a semantic token, as shown in block 204. In one example, a semantic token may be defined as a character that categorizes the substring. A category may be determined for each substring separated by the delimiter. For example, the predetermined substrings mentioned above may be associated with a semantic token that categorizes the predetermined substring. Thus, a timestamp substring may be associated with a “T” semantic token; a date substring may be associated with a “D” semantic token; a new line character may be associated with an “L” semantic token; and, the end of data character may be associated with a “$” semantic token. The foregoing list of predetermined substrings is a non-exhaustive list and other types of predetermined substrings may be presumed in different situations. Furthermore, it should be understood that the character chosen to represent the semantic token is not limited to the foregoing examples. Therefore, a new line character may be associated with, for example, an “M” semantic token.

In the example of FIG. 3, an intermediate semantic token string 310 is shown. Intermediate semantic token string 310 may contain a series of semantic tokens that correspond to the detected substrings in input data 120. That is, the semantic tokens may be ordered in accordance with the order of the substrings associated therewith. In the example of FIG. 3, the substring “12/12/20” may be associated with a semantic token of “D” to indicate that the substring is a date. The substrings “08:01:27, 233,” “08:01:28, 098,” and “08:01:28, 632” may be associated with a semantic token “T” to indicate that the substrings are timestamps. The new line or linefeed character that separates each line in the input data 120 may be associated with the “L” semantic token and the end of data character may be associated with the “$” semantic token. Other substrings that are not predetermined substrings may be associated with a generic token, such as “G” for generic text. For example, in the input data 120, the substrings “Jetlink Stacker” and “Init Start” are deemed to be generic and thus are associated with a “G” semantic token in the intermediate semantic token string 310. Similarly, the substrings “Trolley now online” and “All IOs locations are OK” are also associated with a “G” semantic token in intermediate semantic token string 310. All other substrings that do not fall into these categories may be associated with their own unique semantic token. In the example of FIG. 3, these substrings are associated with themselves. For example, the “[” substring, “]” substring, “,” substring, and “!” substring are each associated with their own unique semantic token, which, in intermediate semantic token 310, are the substrings themselves. Other substrings may be associated with other unique semantic tokens. For example, the number “20” shown between brackets in the second line of input data 120 may be associated with the “N” semantic token, as shown in the intermediate semantic token string 310. The semantic tokens may be arranged in accordance with the substrings detected in the input data 120. Thus, the intermediate semantic token string 310 may represent a high level outline of input data 120.

The intermediate semantic token string 310 may then be further abstracted by determining whether any of the unique semantic tokens should be switched to a generic semantic token. In one example, this determination may include an evaluation of whether each unique semantic token is associated with a recurring substring. In a further example, a recurring substring may be defined as a substring that appears at least once between each pair of predetermined substrings. Each recurring substring may also be associated with its own plausibility score that measures the plausibility that a significant pattern of the substring exists in the input data such that the recurring substring merits its own unique semantic token. In one example, the number of times a recurring substring appears between each pair of predetermined substrings may be determined. The number of appearances that is most frequent (i.e., the mode of the number of appearances) may be detected. Thus, in one example, the plausibility score for the recurring substring may be defined as: Mₙ/Pₛ, where Mₙ is the number of predetermined substring pairs in which the number of a recurring substring therein is equal to the mode of the appearances and Pₛ is the total number of predetermined substring pairs. If the plausibility score for the recurring substring exceeds a predetermined threshold, it may be associated with its own unique semantic token. Otherwise, if the plausibility score falls below the predetermined threshold, the recurring substring may be associated with the generic semantic token, such as the “G” semantic token illustrated earlier. In one example, the predetermined threshold is 0.6. Furthermore, substrings that do not appear at least once between each pair of predetermined strings may also be associated with a generic semantic token.

Referring to the intermediate semantic token 310 in FIG. 3, the first pair of predetermined substrings may include the first pair of new line characters associated with the “L” semantic token. Between the first pair of “L” semantic tokens, the “[” substring and the “]” substring appear once and the “,” substring appears twice. Between the second pair of “L” semantic tokens, the “[” substring and the “]” substring appear twice, the “,” substring appears once, and the semantic token “N”, which is associated with the number “20,” appears once. In the last line, the end of data substring may be included in the pair. Thus, the semantic tokens associated with the last pair of predetermined substrings may include “L” and “$.” Between the last pair of predetermined substrings the “[” substring, the 1″ substring, the “,” substring and the “!” substring appear once. The following may be a summary of the appearances for each substring mentioned above as they appear between each pair of predetermined substrings:

“]”=[1, 2, and 1]

“[”=[1, 2, and 1]

“,”=[2, 1, and 1]

“N”=[0, 1, and 0]

“!”=[0, 0, 1]

As shown above, the “]” substring appears once between the first pair of predetermined substrings, twice between the second pair of predetermined substrings, and once between the third pair of predetermined substrings. The mode, which is 1, appears between two pairs of predetermined substrings and the total number of pairs is three. Thus, using the example formula Mₙ/Pₛ for the “]” substring results in ⅔=.66. Assuming a threshold of 0.6, the substring “]” may be deemed worthy of its own unique semantic token. As with the “]” substring, the plausibility formula for the “[” substring is also ⅔=.66 and may also be deemed worthy of its own unique semantic token in view of the example threshold 0.6. Similarly, the “,” substring appears once between 2 out of 3 pairs, which results in ⅔=.66. Thus, the “,” also exceeds the example threshold of 0.6 and may be deemed worthy of its own unique semantic token. The substring “20,” which is represented by the semantic token “N,” and “!” do not appear between each pair of predetermined substrings. As such, the semantic token “N” and “!” may be switched to the example “G” generic semantic token. Referring back to FIG. 3, a final semantic token string 320 is shown in which the “N” semantic token is replaced with a “G” generic semantic token and the “!” semantic token is merged with the “G” semantic token. The semantic token string 320 may be the final outline of input data 120 that includes unique semantic tokens for substrings deemed worthy of consideration during formulation of the parsing rules. As with intermediate semantic token 310, the semantic tokens in semantic token string 320 may be ordered in accordance with the order of the substrings associated therewith such that semantic token string 320 is an outline of input data 120.

Referring back to FIG. 2, patterns of semantic tokens may be identified, as shown in block 206. In one example, to identify patterns in the semantic tokens, different suffix string combinations in semantic token string 320 may be stored in a suffix tree data structure. In one example, the suffix tree data structure may be implemented as a minimal augmented suffix tree data structure containing a hierarchy of interlinked nodes in which the edges thereof are associated with substrings of the semantic token string, such that each suffix of the semantic token string corresponds to a path from the root node to a leaf node. Furthermore, each interior node of the minimal augmented suffix tree data structure may contain a number that represents the frequency of each substring associated therewith in the semantic token string, while avoiding overlap between substrings therein. For example, FIG. 4 shows an illustrative suffix tree data structure 400 that may be used to represent the different suffixes in semantic token string 320. Due to the high number of suffix combinations in semantic token string 320, only a portion of the suffix tree is shown for ease of illustration. The root node 402 of suffix tree 400 is shown containing the number 27, which is the number of characters in semantic token string 320. The edge between root node 402 and intermediate node 404 is associated with a semantic token substring “L [D, T],” which appears three times in semantic token string 320. As such, intermediate node 404 may contain the number 3 to indicate the frequency of this semantic token substring in the semantic token string 320. The next node in the hierarchy after intermediate node 404 is intermediate node 406. The substring therebetween may be the “G” semantic token substring. The number 2 in intermediate node 406 may indicate that the semantic token substring “L [D, T] G” appears twice in semantic token string 320. Intermediate node 406 may be associated with two leaf nodes, leaf node 414 and leaf node 416. Between intermediate node 406 and leaf node 414 is the “, G” semantic token substring. The leaf node 414 is shown having a value of 1 therein. In this example, the value 1 in leaf node 414 may represent the starting position of the suffix represented by the branch beginning at root node 402 and ending at leaf node 414, which is the “L[D,T]G,G” suffix. As shown in semantic token string 320, the suffix “L [D, T] G, G” begins at the first position (beginning from the left in this example) of semantic token string 320. As with leaf node 414, leaf node 416 may also contain the starting position of the “L [D, T] G$” suffix string represented by the branch beginning at root node 402 and ending at leaf node 416. As indicated in leaf node 416, this suffix begins at position 20 of semantic token string 320. In the example of FIG. 4, the nodes of suffix tree 400 may be sorted by the frequency number stored in each node such that the nodes and associated substrings having higher frequency numbers may be placed closer to the root of the tree.

The rest of suffix tree data structure 400 may be arranged similarly. Each leaf node may contain the starting position of its corresponding branch and each intermediate node may contain the frequency of the substrings associated with the branches that precede them. Leaf node 418 may contain the number 10, since the suffix string “L [D, T] [G] GL” of its corresponding branch begins at position 10 in semantic token string 320. The intermediate nodes 408, 410, and 412 may represent the suffixes “[D, T] G, G” and “[D, T] G$.” The former beginning at position 2, as indicated by leaf node 420, and the later beginning at position 21, as indicated by leaf node 422. The branch beginning at root node 402 and ending at leaf node 424 may represent the “[D, T] [G] GL” suffix, which begins at position 11 as indicated in leaf node 424. The branch beginning at root node 402 and ending at leaf node 426 may represent the “[G] GL [D,” suffix, which begins at position 16 as indicated by leaf mode 426. The branch beginning at root node 402 and ending at leaf node 426 may simply represent the “$” semantic token, which is located at position 27 as indicated by leaf node 428. Different combinations of suffix strings may be stored in this manner in suffix tree data structure 400. Once the suffix string combinations have been exhausted and arranged in suffix tree data structure 400, a cycle discovery algorithm may be executed to derive the parsing rules.

Referring back to FIG. 2, parsing rules for records in the input data may be formulated at least partially on the patterns of semantic tokens, as shown in block 208. Referring again to FIG. 4, the output of the cycle discovery algorithm may be a path in the suffix tree beginning at root node 402. If the suffix tree data structure 400 is very large, it may be inefficient to test every node therein. Thus, in one example, only the most frequently occurring semantic token substrings may be considered such that any substrings falling below a frequency threshold may be deemed irrelevant. In a further example, the first O(log n) most frequently occurring substrings may be considered when formulating the record parsing rules, where n is the length of the semantic token string. The substrings whose frequency falls below the O(log n) threshold may be ignored. For ease of illustration, substrings associated with nodes 402 thru 412 may be the only nodes considered in the example of FIG. 4. Each substring associated with these nodes may be compared to the semantic token string 320. The substring with the least amount of “edit distance” with the semantic token string 320 may be the chosen substring. The chosen substring may be used to formulate a parsing rule for records in the input data 120. In one example, edit distance may be defined as the number of characters in a string that are not in a substring pattern appearing in the string. For example, the “L [D, T]” substring associated with node 404 appears three times in semantic token string 320. The first occurrence appears in positions 1 thru 6, the second occurrence appears at positions 10 thru 15, and the final occurrence appears at positions 20 thru 25. The characters that are not in each appearance of the substring associated with node 404 are the “G, G” substring (positions 7-9), the “[G] G” substring (positions 16-19), and the “$” substring (position 27) for a total of eight characters. Thus, the edit distance score associated with the substring of node 404 is eight. The substring associated with node 406 is the “L [D, T] G” substring. The first occurrence appears in positions 1 thru 7 and the second occurrence appears in positions 20 thru 26. However, the characters in the substring need not appear consecutively. Thus, the third occurrence appears in positions 10 thru 15 and position 17. The extra “[” character in position 16 may be counted toward the edit distance. In between these three appearances are “, G” (positions 8-9) and “] G” (positions 18-19), which add four more points towards the edit distance score. Thus, the edit distance score associated with node 406 is 5. The same process may be repeated for nodes 408, 410, and 412. In this example, the “L [D, T] G” substring associated with node 406 has the lowest edit distance score. As such, the “L [D, T] G” substring may be deemed the format of the records in input data 120 and the input may be parsed accordingly.

Referring back to FIG. 3, assuming the semantic token string “L [D, T] G” corresponds to the format of the records in the input data 120, the data may be parsed accordingly. The semantic tokens in the winning format may facilitate the parsing of fields in the records. The following table illustrates the parsing of the records and fields corresponding to the “L [D, T] G” format:

| L | [ | D | , | T | ] | G |
|---|---|---|---|---|---|---|
| /n | [ | 12/12/20 | , | 08:01:27,233 | ] | Jetlink Stacker, |
| | | | | | | Init Start |
| /n | [ | 12/12/20 | , | 08:01:28,098 | ] | [20] Trolley now |
| | | | | | | online |
| /n | [ | 12/12/20 | , | 08:01:28,632 | ] | An IOs locations |
| | | | | | | are OK! |

Advantageously, the above-described computer apparatus, non-transitory computer readable medium, and method derive parsing rules for data that does not adhere to any known format. In this regard, data that is not readily interpretable by a user may be parsed even when the boundaries between the records and fields are not known in advance. In turn, users can be rest assured that the data will be readable regardless of the changes made in the format of the data.

Although the disclosure herein has been described with reference to particular examples, it is to be understood that these examples are merely illustrative of the principles of the disclosure. It is therefore to be understood that numerous modifications may be made to the examples and that other arrangements may be devised without departing from the spirit and scope of the disclosure as defined by the appended claims. Furthermore, while particular processes are shown in a specific order in the appended drawings, such processes are not limited to any particular order unless such order is expressly set forth herein. Rather, processes may be performed in a different order or concurrently and steps may be added or omitted.

1. A system, the system comprising:
a processor to:
determine at least one rule for partitioning input data into substrings, each substring comprising at least one character;
associate each substring with a semantic token that categorizes each substring;
identify patterns of semantic tokens; and
formulate parsing rules for records in the input data based at least partially on the patterns of semantic tokens.

2. The system of claim 1, wherein the processor is a processor to parse the input data using the parsing rules.

3. The system of claim 1, wherein the parsing rules include a parsing rule for fields in the records.

4. The system of claim 1, wherein the substrings in the input data include:
a delimiter that separates the substrings in the input data;
predetermined substrings, each predetermined substring being associated with a predetermined type, the predetermined substrings being substrings presumed to appear in the input data; and
recurring substrings, each recurring substring being a substring that appears at least once between each pair of predetermined substrings.

5. The system of claim 4, wherein detection of the delimiter is based on a plausibility score associated with the delimiter, the plausibility score being based on a percentage of lines containing at least one appearance of the delimiter and a number of appearances of the delimiter in the input data.

6. The system of claim 4, wherein to associate each substring with the semantic token the processor is a processor to:
determine whether a plausibility score associated with each recurring substring exceeds a threshold; and
associate each recurring substring with the semantic token that categorizes each recurring substring, when the plausibility score associated therewith exceeds the threshold.

7. The system of claim 6, wherein the processor is a processor to associate each predetermined substring with the semantic token that categorizes the predetermined substring.

8. The system of claim 6, wherein if the plausibility score falls below the threshold, the processor is a processor to associate each recurring substring with a generic semantic token.

9. The system of claim 1, wherein to identify patterns of semantic tokens, the processor is a processor to:
generate a string of semantic tokens that outline the substrings in the input data;
store the semantic tokens in a suffix tree data structure; and
analyze the suffix tree data structure to identify patterns in the semantic tokens stored therein.

10. A non-transitory computer readable medium having instructions stored therein which, if executed, causes a processor to:
detect a delimiter that separates substrings in an input data, each substring in the input data comprising at least one character; and
determine a category for each substring separated by the delimiter;
associate each substring with a semantic token that categorizes each substring;
generate a string of semantic tokens such that the semantic tokens are ordered in accordance with an order of the substrings associated therewith;
identify patterns in the string of the semantic tokens using a suffix tree data structure; and
formulate parsing rules for records in the input data based at least partially on the patterns of semantic tokens identified in the suffix tree data structure.

11. The non-transitory computer readable medium of claim 10, wherein detection of the delimiter is based on a plausibility score associated with the delimiter, the plausibility score being based on a percentage of lines containing at least one appearance of the delimiter and a number of appearances of the delimiter in the input data.

12. The non-transitory computer readable medium of claim 10, wherein the substrings comprise predetermined substrings, each predetermined substring being associated with the semantic token that categorizes the predetermined substring, each predetermined substring being a substring that is presumed to appear in the input data.

13. The non-transitory computer readable medium of claim 12, wherein, to associate each substring with the semantic token, the instructions stored therein, if executed, further causes the processor to:
detect each recurring substring, each recurring substring being a substring that appears at least once between each pair of predetermined substrings.
determine whether a plausibility score associated with each recurring substring exceeds a threshold; and
associate each recurring substring with the semantic token that categorizes each recurring substring, when the plausibility score associated therewith exceeds the threshold.

14. The non-transitory computer readable medium of claim 13, wherein the instructions stored therein, if executed, further causes the processor to associate each recurring substring with a generic semantic token, when the plausibility score associated therewith falls below the threshold.

15. The non-transitory computer readable medium of claim 14, wherein the instructions stored therein, if executed, further causes the processor to associate each substring not appearing at least once between each pair of predetermined substrings with the generic token.

16. A method comprising:
detecting, using a processor, substrings in an input data, each substring comprising at least one character;
associating, using the processor, each substring with a semantic token that categorizes each substring;
generating, using the processor, a string of semantic tokens such that the semantic tokens are ordered in accordance with an order of the substrings associated therewith;
storing, using the processor, the string of semantic tokens in a suffix tree data structure;
analyzing, using the processor, patterns in the string of semantic tokens using the suffix tree data structure;
formulating, using the processor, parsing rules for records in the input data based at least partially on the patterns of semantic tokens identified in the suffix tree data structure; and
parsing, using the processor, the input data using the parsing rules.

17. The method of claim 16, wherein detecting substrings in the input data comprises:
detecting, using the processor, a delimiter that separates the substrings in the input data;
detecting, using the processor, predetermined substrings that are presumed to appear in the input data, each predetermined substring being associated with the semantic token that categorizes the predetermined substring; and
detecting, using the processor, each recurring substring, each recurring substring being a substring that appears at least once between each pair of predetermined substrings.

18. The method of claim 17, wherein associating each substring with the semantic token comprises:
determining, using the processor, whether a plausibility score associated with each recurring substring exceeds a threshold; and
associating, using the processor, each recurring substring with the semantic token that categorizes each recurring substring, when the plausibility score associated therewith exceeds the threshold.

19. The method of claim 18, further comprising:
associating, using the processor, each recurring substring with a generic semantic token, when the plausibility score associated therewith falls below the threshold; and
associating, using the processor, each substring not appearing at least once between each pair of predetermined substrings with the generic semantic token.
